(19) United States
(12) Patent Application Publication
(10) Pub. No.: US 2025/0278807 A1
(43) Pub. Date: Sep. 4, 2025

(54) MODERN MONETARY THEORY AND TRANSLATIONAL SCIENTIFIC RESEARCH

(71) Applicant: Joel Steven Goldberg, Hillsborough, NC (US)

(72) Inventor: Joel Steven Goldberg, Hillsborough, NC (US)

(21) Appl. No.: 19/191,666

(22) Filed: Apr. 28, 2025

(51) Int. Cl. G06Q 50/26; G06Q 40/06; H01M 12/00

(52) U.S. Cl. CPC G06Q 50/26; G06Q 40/06; H01M 12/00

(57) ABSTRACT

This invention demonstrates that direct government funding of translational science research can elevate the standard of living of constituents of sovereign currency-issuing countries and is preferable to funding full employment of the involuntary unemployed as espoused in modern monetary theory (MMT). Full employment of the involuntary unemployed population through government public work programs is an unproven economic policy which suffers from political obstacles as well as inflationary concerns and may promote a population of marginally productive federal workers. Unlike MMT direct government investment in successful transformative translational scientific research will increase real GDP per capita and lower prices benefiting from multiplier effects and acquisition of intellectual property. Numerous examples of translational scientific research based on sound scientific principles are presented, which are likely to be successful but may disrupt the profit motives of corporations or established plans of nonprofits and academia.

### CROSS-REFERENCE TO RELATED APPLICATIONS

This application claims the benefit of U.S. application Ser. No. 18/797,623, Ser. No. 18/400,025, Ser. No. 18/373,387, Ser. No. 18/114,262, Ser. No. 17/958,328, Ser. No. 17/698,053, Ser. No. 17/589,004, Ser. No. 17/575,735, Ser. No. 17/526,163, Ser. No. 16/924,375, Ser. No. 16/876,647, Ser. No. 16/706,760 Ser. No. 16/435,479, Ser. No. 16/431,497, Ser. No. 16/139,062, Ser. No. 16/027,324, Ser. No. 15/990,011, Ser. No. 15/827,958, Ser. No. 15/463,205, Ser. No. 15/438,955, Ser. No. 15/337,155, Ser. No. 15/191,673, Ser. No. 15/172,251, Ser. No. 15/131,665, Ser. No. 15/057,146, Ser. No. 14/995,376, Ser. No. 14/991,931, Ser. No. 14/844,202, Ser. No. 14/663,911, Ser. No. 14/520,089, Ser. No. 14/304,205, Ser. No. 14/221,899, Ser. No. 14/182,011, Ser. No. 14/167,028, Ser. No. 14/057,506, Ser. No. 13/613,736, and Ser. No. 13/360,567 which are incorporated by reference.

### FEDERALLY FUNDED RESEARCH

Not applicable

### BACKGROUND OF THE INVENTION

Modern monetary theory (MMT) embraces an economic policy that includes:
1. Full employment of the involuntary unemployed
2. Low inflation
3. Price stability

MMT is based on sovereign currency issuing countries which have monopolistic currency control that enables these countries to engage in deficit spending to improve the standard of living of their constituents.[1, 2] Proponents of MMT believe that full employment of the involuntary unemployed population through government public work programs is possible with acceptable inflation. Inflation can be controlled with taxation rather than with monetary interventions such as interest rates. Government fiscal deficits are of secondary importance if inflation is acceptable, and U.S. government spending programs should be preemptively evaluated for inflation risks by the Congressional Budget Office prior to legislation. MMT views economic and political policy success as establishing economic stability with decreased poverty, decreased unemployment, and decreased economic inequality. MMT considers fiscal balancing to be more politically motivated than economically correct.

Opponents of MMT believe that government fiscal deficits will produce difficult to control inflation which will be recognized in hindsight rather than in real time, and full employment of the involuntary unemployed is not possible because there is a natural rate of structural and frictional unemployment along with business cycle components. Obstacles to government public work programs include establishing a marginally productive, low incentive work force with guaranteed job security and unacceptable inflation. Without constraints on debt, governments can use short term spending to try to resolve problems that may impact long term economic viability. Prediction of inflationary risks of new government fiscal policies may be inaccurate. Historically, there are significant risks of hyperinflation when governments print money without tight controls.

In contrast to the full employment of MMT, this invention proposes that direct government funding of translational scientific research is more likely to uplift the standard of living of societies than government public programs for the involuntary unemployed, and direct government investment in translational scientific research will increase real GDP per capita and lower prices with increased efficiencies, increased employment, and increased intellectual property.

In most economically developed societies, profit motives do not directly align with improved standard of living. There is considerable time lag implementing new technologic development, and development may be especially disruptive to the status quo. Corporations, nonprofit organizations, and universities have sunk cost in existing technologies, and the inertia to embrace change is high. There are criticisms that governments cannot develop technologies which go to market faster than private for-profit businesses but sovereign currency issuing countries have the proven capacity to undergo the risk of sponsoring translational scientific research and absorb the losses that are inevitable for development. Governments should invest directly in translational scientific research to improve standard of living, especially in high inflationary disciplines such as health care, energy, agriculture, and defense. In the U.S., direct governmental investment would be analogous to earlier successful large projects such, as the Manhattan project, NASA, the Hoover Dam, the Internet, and the Interstate Highway System.

When comparing MMT to direct investment in translational scientific research, there are clearly great differences in these fiscal policies:
1. Full employment of the involuntary unemployed will increase real GDP but increase price levels. Investment in translational scientific research will increase real GDP with lower prices (FIGS. 1&2) and produce transformative growth by positively shifting the production possibility frontier.
2. MMT focuses on the full employment of the involuntary unemployed, yet voluntary unemployed such as those in the population who do not want to work will still exist. Direct government investment in translational scientific research will benefit the entire population, including all subsets of the labor force; however, funds will likely be shifted from other government programs.
3. A technological advance from translational scientific research is more egalitarian than full employment since it benefits all the population.
4. Investment in translational scientific research will increase the quality of products and services unlike full employment. Transformative technology lowers costs and improves standard of living. Tracing advancement of human civilization even before the Industrial Revolution, transformative technology is largely responsible for this ascent.
5. Full employment of the involuntary unemployed through federal work programs may compete with state and local government labor forces. Governmental investment in translational scientific research is not crowding out investments in the private sector since these projects are high risk, high cost with possibly delayed future returns.
6. Investment in translational scientific research will promote mass production and efficiencies through economies of scale and will decrease costs and prices unlike full employment of the involuntary unemployed.
7. Investment in translational scientific research increases government intellectual capital which can be sold or licensed and can potentially lower taxes. Presently, government ownership of intellectual property is a small source of revenue but is predicted to grow with investment in translational scientific research. Passing on this cost to consumers can be regulated to avoid monopolistic or oligopolistic abuses. Intellectual property is a future driven economic force unlike full employment of the involuntary unemployed.
8. Direct governmental investment is preferable to third party investment which is associated with hefty indirect costs. These indirect costs levied by nonprofits and universities can approach 70% of federal grants since governments are often assumed to have “deep pockets.” Depending upon how the public job guarantee is constructed, third party payments may dilute the benefits of full employment of the involuntary unemployed.
9. The logistics of full employment job matching may be a significant hurdle in implementing MMT, and there may be a work force of mismatched labor. This problem is unlikely to be a significant factor associated with investment in translational scientific research which may likely employ unskilled and highly skilled labor, as has occurred in earlier directly invested government projects.
10. Transformative growth from investment in translational scientific research may increase real GDP per capita compared to increases in full employment of the involuntary unemployed, since federal job guarantees will produce low paid workers who will consume less than higher paid workers.

### Health Care

Cultural evolution has produced mismatched diseases such as Type II diabetes and obesity which have decreased mortality at the expense of increase disability adjusted life years with increased expenditures. In the U.S., health care is approximately 20% of GDP. U.S. health care costs have consistently outpaced inflation, and U.S. health care is consistently rated below many developed countries for the following reasons:
1. Pharmaceutical and device companies do not support nonproprietary translational research because of slim profit margins.
2. The randomized placebo control trial for FDA pharmaceutical and device approval is outdated and inflationary. Potential new pharmaceuticals and devices should be trialed against known FDA approved or traditionally established treatments with a placebo arm before issuing new approvals.[3] More effectiveness or a more benign side effect profile compared to existing therapies should be required for FDA approval.
3. Third party (insurance or government) payments inflate health care costs.
4. Conflict of interest is reported but is rampant in health care publications, demonstrating tight relationships between health care providers and pharmaceutical and medical device manufacturers, promoting new therapies of marginal efficacy that are inflationary. Published controlled clinical trials most commonly list health care authors who received compensation from corporations outside of their direct clinical care. There is an incentive for authors to interpret ambiguous data in favor of corporate or academic sponsors.
5. Academic and corporate research sunk costs do not encourage adaptation to changing data that suggest discontinuing present trajectories. Corporations and academicians are reluctant to reassign personnel who have specialized skills that cannot be placed in suitable positions within their organization.
6. Prevention of disease is underfunded.

### Translational Scientific Research That Should Be Directly Funded By The US Government

### Cancer

Progress in cancer cure has been slow and enormously expensive. Estimates of cancer costs to world economies have been grossly underestimated since such estimates do not account for cancer screening, which includes tests to “rule out,” and corporate and government liability claims from jury awards that are based on correlations between “suspected” cancer causes.

One hallmark of cancer is unregulated locally invasive and distant metastatic cell growth which destroys organs and leads to death. Another hallmark, hypothesized in 1924 by Otto Warburg, one of the preeminent scientists of the 20^{th} century, is that cancer cells nearly uniformly use glycolysis for ATP production. Unknown at the time and discovered later, glycolysis not only serves to provide cell energy, but it is the main pathway for synthesis of D-ribose, the 5-carbon sugar required for synthesis of ATP, GTP, DNA, RNA, NAD, NADP, FAD, and Coenzyme A. Without available stores of D-ribose, cancer cells cannot rapidly proliferate, and the bioavailability of D-ribose that is supplied by diet may be limited. In humans, infusion of D-ribose-1-C¹⁴ is excreted unchanged in the urine and expired as C¹⁴O₂, suggesting that D-ribose is directly oxidized or converted to D-glucose which is then oxidized.[4] Therefore, dietary supplementation with D-ribose may not be adequate to supply rapidly dividing cancer cells. Scavenging D-ribose and/or synthesizing D-ribose from the pentose phosphate pathway may be the predominant means to supply rapidly replicating cancer cells with this needed sugar, and this explains the chemotherapeutic effects of interruption of the pentose phosphate pathway.

Sequestration of L-lactate by D-Lactic Acid Dimer (DLAD), a spontaneous non-enzymatic chemical reaction that occurs at body temperature, was discovered in 2016.[5, 6] DLAD was subsequently shown to inhibit growth in vivo of melanoma tumors and in vitro of other malignant cell cultures, and DLAD is U.S. patent protected for the treatment of cancer.[7] Inhibition of melanoma cell proliferation was conclusively shown with DLAD compared to L-lactic acid dimer (P<0.0001) which has similar properties of pH, lipid solubility, and molecular weight.[8] Intralesional application of DLAD has demonstrated a dose response tumoricidal activity, and could easily be developed as a treatment for skin cancers, but there is no pharmaceutical incentive to pursue this research. DLAD sequesters L-lactate, shifting the pyruvate to L-lactate equilibrium and inhibiting hydrogen ion transport needed for supporting glycolysis within the tumor cell. DLAD disrupts L-lactate availability as a potential fuel for cancer cells. At pH 7 the drug lost efficacy, but the tumor microenvironment is often much more acidic, suggesting that systemic administration could be effective. This mechanism of DLAD action, sequestration of L-lactate, is unique and further confirms Warburg's hypothesis that energy production is the therapeutic link for treatment of cancer. For systemic therapy DLAD, may be bioavailable as an ester prodrug.

2-Deoxy-D-Glucose (2DG), a known chemotherapeutic agent, blocks glycolysis and the formation of D-ribose via the pentose phosphate pathway at the initial phosphorylation of glucose in glycolysis. One combination cancer therapy includes 2DG and DLAD, two inexpensive low molecular weight drugs, each of which have been shown in vitro and in vivo to inhibit growth of a wide variety of cancer cells. Therefore, antiglycolytic therapy which interrupts production of D-ribose and ATP has been proposed as a treatment for cancer. Monitoring this antiglycolytic therapy can be easily achieved by measuring red blood cell (RBC) hemolysis, since mature RBC without mitochondria rely exclusively on glycolysis for ATP production.[9] Antiglycolytic therapy may have broad implications beyond cancer treatment since many diseases upregulate glycolysis to survive. There is little profit incentive for a pharmaceutical company to pursue this research. Direct government funding for this translational research is needed.

Key concepts: (1) Intralesional application of DLAD is a treatment for skin cancers. (2) Cancer is an aberration of cell energy use which can be treated with antiglycolytic therapy comprising 2DG and DLAD, and the treatment can be monitored by RBC hemolysis. (3) Antiglycolytic therapy may be applicable for the treatment of hypermetabolic diseases which depend upon upregulation of ATP.

### Atherosclerosis

Atherosclerosis as the etiology of heart, peripheral vascular, and cerebral vascular disease is the leading cause of death in developed countries. The most widely accepted cause of atherosclerosis is deposition of lipids, in particular low-density lipoprotein (LDL)-cholesterol and apolipoprotein B, producing an inflammatory effect on blood vessels which leads to vessel wall atherosclerosis. However, independent of location, nearly all atherosclerotic lesions contain calcium primarily in the form of calcium hydroxyapatite (CaHA), which adds structural support to arterial blood vessels subjected to changes in laminar flow at arterial bifurcations. This is a possible explanation for the common locations of atherosclerosis in the aorta, and coronary, carotid, and superficial femoral arteries.[11] Calcium computer tomography scanning, which mostly detects CaHA, has been shown to be a predictor of ischemic heart disease in patients independent of lipid abnormalities.[12] CaHA is commonly detected in microscopic sections in the intimal and medial arterial blood vessels and can be confirmed in vivo with fluorine-18 PET scanning.[13]

Removing CaHA from disease blood vessels is challenging since the Kₛₚ of CaHA is 6.8×10⁻³⁷ in human teeth, which most likely approximates the Kₛₚ of CaHA in arterial blood vessels. Citrate chelation of calcium within the CaHA matrix is complicated but probably proceeds through the replacement of phosphate with citrate and reorganization of the CaHA matrix.[14] Dissolution of CaHA is entropically favored. For years it has been known that citric acid can dissolve CaHA in tooth enamel. Calcium chelating agents have been successful in vitro and in vivo dissolving CaHA in bone and arterial vessels. Choline citrate and sodium citrate administered intraperitoneally decreased thoracic atheroma in cholesterol-fed rabbits.[15] In humans, the clinical trials with ethylenediaminetetraacetic acid (EDTA) chelation have been controversial, but in vitro citrate has been shown to chelate calcium within the CaHA matrix.[16]

Triethyl citrate (TEC) is an inexpensive drug and FDA approved food additive with known low toxicity that can chelate calcium ions and may be a preferred alternative to EDTA.[17] TEC is readily hydrolyzed by cholinesterase to citrate and ethanol. Although most citrate is metabolized by the liver it may be possible to systemically administer TEC with elevation of plasma citrate levels that are therapeutic. Direct government funding for this translational research is needed.

Key concept: Atherosclerosis is an aberrant deposition in arterial vessels of CaHA which provides structural integrity to hemodynamic stressed arteries, and TEC chelation of calcium ions within the CaHA matrix may be therapeutic.

### Cerebrovascular Accident (CVA) or Stroke

Stroke is a major source of mortality and morbidity, and patients who survive stroke require chronic, expensive rehabilitation. CVA caused by plaque occlusion, embolism, or hemorrhage decreases oxygen partial pressure (PP) within the completely ischemic or penumbra tissues, producing a PP deficit that is replaced by gases known to exist within the brain such as nitrogen, carbon dioxide, carbon monoxide and nitric oxide. The PP of carbon dioxide competes with a buffer system, so it is less likely to increase within the ischemic tissue void, and the PP of carbon monoxide and nitric oxide are quite small. Nitrogen is the most abundant of these gases, and as the PP of nitrogen increases in areas of ischemia, it poisons cells particularly within the inner mitochondrial matrix where oxidative phosphorylation occurs. Nitrogen poisoning of ischemic mitochondria was deduced by VanDeripe studying electron microscopic sections.[18, 19] It is predicted that denitrogenation with oxygen supplementation will reduce morbidity and mortality from stroke. A randomized controlled trial is needed for proof of concept but there is little profit incentive. Direct government funding for this translational research is needed.

Key concept: CVA increases nitrogen PP in the inner mitochondrial matrix in brain tissue inhibiting ATP production, and this condition can be treated with denitrogenation and supplemental oxygen.

### Alzheimer's Disease

Alzheimer's disease, characterized by amyloid plaques and neurofibrillary tangles in the brain, is a rapidly rising cause of morbidity and mortality requiring chronic expensive care for which no good treatment options exist. The FDA has approved several expensive medications for this condition that provide marginal benefit. The most expensive are those medications that dissolve beta amyloid plaques which can be modeled in vitro by incubating beta amyloid peptide (1-40) with calcium ions to form beta amyloid aggregates. Conversely, these beta amyloid aggregates produced in vitro can be dissolved with citrate presumptively through chelation of calcium ions with restoration of normal protein folding and loss of Thioflavin T fluorescence.[21] TEC crosses the blood brain barrier (BBB) and is likely hydrolyzed in the central nervous system (CNS) by cholinesterases to ethanol and citrate, which can chelate calcium ions presumptively dissolving amyloid plaques. Administration of TEC is a U.S. patented treatment for Alzheimer's disease.[17] Pharmaceutical companies have no interest in pursuing this research which would disrupt prescription of present expensive marginally effective drug therapies. Direct government funding for this translational research is needed.

Key concept: Alzheimer's disease can be treated by dissolution of beta amyloid plaques with TEC chelation of calcium ions.

### Chronic Pain

Chronic pain afflicts more than a billion humans and is a significant cause of morbidity and mortality, especially suicide. There are a diverse number of treatments for chronic pain and rarely a single modality is effective. Many modalities have unacceptable side effects. For two decades pharmaceutical companies have tried to develop a selective sodium channel blocker that has the potential to ameliorate neuropathic pain and possibly pain not presently classified as neuropathic. In 2025 Vertex Pharmaceuticals was granted FDA approval for suzetrigine, a novel very expensive sodium channel blocker, for the treatment of acute pain which has similar efficacy as very inexpensive 5 mg hydrocodone/325 mg acetaminophen, and no better efficacy than placebo in phase II trials for chronic lumbar radicular pain.[22, 23] However, with FDA approval, suzetrigine could be prescribed off label for chronic pain since opioid phobia still exists among patients and practitioners, even though present drug overdoses in the U.S. are primarily from illicit fentanyl and its congeners.

Procaine, a sodium channel blocker with over 100 years of clinical use, is orally bioavailable, and procaine or a congener of procaine may be an effective inexpensive orally administered sodium channel blocker; however, there is no profit incentive for a pharmaceutical company to investigate this potential systemic analgesic, which would be disruptive to present expensive therapies.[24] Direct government funding for this translational research is needed.

Topical administration of a hydrogel comprised of DLAD has been shown to produce analgesia presumably though sequestration of L-lactate which is a unique mechanism of action.[25, 26] No adverse effects were noted in a compassionate use trial; however, a pharmaceutical company has not been interested in pursuing this research.

Intractable chronic pain that cannot be controlled with medications, stimulation therapies, injections, and behavioral therapies is extremely rare but may require destructive neurosurgical lesions for control. Neurosurgical lesions are produced by physical destruction with a knife, cautery, ultrasound, or with gamma knife radiosurgery. This neurolysis of pathways may include known opioid mediated pathways and/or non-opioid ascending nociceptive pathways.[27] Magnetic fields carry energy that may be best targeted with a Helmholtz coil, and magnetic fields with the proper frequency, amplitude, and conformation have the capacity to lesion pain generating neural tissue producing bloodless surgery.[28]

Key concepts: (1) Inexpensive oral procaine or its congeners may provide analgesia by blocking sodium channels in nerves and neurons. (2) Topical hydrogel DLAD is an analgesic with a unique mechanism of action. (3) Magnetic fields of select frequencies, amplitudes and conformation can penetrate the CNS and lesion pain generating neural tissue producing analgesia with potential bloodless surgery for treatment of rare intractable chronic pain.

### Malaria

Worldwide malaria is a significant cause of morbidity and mortality, but the disease is limited in the US. The asexual blood stages of Plasmodium parasite infect mature RBC that lack mitochondria and rely on glycolysis for ATP rather than oxidative phosphorylation absent in mature RBC. Plasmodium also require sufficient D-ribose to asexually replicate, which may be available by scavenging and/or hijacking the D-ribose manufactured in RBC by the pentose phosphate pathway. Presently artemisinin resistant strains are evolving, which will increase morbidity and mortality. Artemisinin and its congeners are expensive to synthesize or isolate from Artemisia annua extraction. The mechanism of action of artemisinin is most likely related to breaking the endoperoxide ring which produces free radicals that can destroy Plasmodium. It is predicted that antiglycolytic therapy with 2DG and DLAD will inhibit Plasmodium replication.[29] There is no incentive for a pharmaceutical company to develop this antiglycolytic therapy. Direct government funding for this translational research is needed.

Key concept: Plasmodium relies on glycolysis for asexual replication in RBC and can be treated with 2DG and DLAD antiglycolytic therapy.

### Amyotrophic Lateral Sclerosis (ALS)

ALS is primarily a disease of high energy, requiring motor nerves for which there is no known cure. In general, motor nerves require more energy than sensory or autonomic nerves for impulse propagation, and long motor nerves require more energy than short motor nerves for impulse propagation independent of myelinization. This relationship explains the ALS phenotype with early ocular and sphincter sparing.[30] Administration of L-lactate has been shown in vivo and in vitro to provide an energy substrate for nerves and neurons and may improve the symptoms of ALS. LDH1, commonly found in neurons and possibly nerves, catalyzes L-lactate to pyruvate which is a source for ATP. The liver metabolizes approximately 70% of L-lactate administered with oral or parental administration, but it is possible to increase CSF L-lactate with supplementation, since L-lactate infusions have been known to induce symptoms of panic attacks and post-traumatic stress disorder (PTSD). There is no profit incentive for a pharmaceutical company to explore this inexpensive therapy. Direct government funding for this translational research is needed.

Key concept: Symptoms of ALS can be treated with L-lactate, a source of energy, for high energy requiring motor nerves and neurons.

### Parkinson's Disease

Diagnosis of Parkinson's disease (PD) poses many diagnostic dilemmas and may be expensive if genetic studies and scans are required. The initial primary deficit in PD is degeneration of high energy dopaminergic neurons which form an extensive unique arborization pattern orders of magnitude larger than any other neuron types and inherent pacemaker activity, both of which require high sustained levels of ATP. Pretreatment with nicotinamide to increase CNS NAD⁺ and L-lactate infusion as an energy source with concomitant monitoring of signs and symptoms of tremor, cogwheel rigidity, and glabellar reflex may inexpensively improve the early diagnosis of this disease.[31] Direct government funding for this translational research is needed.

Key concept: PD preferentially affects high energy requiring dopaminergic neurons and can be diagnosed monitoring common signs of tremor, cogwheel rigidity, and glabellar reflex during an intravenous infusion of L-lactate in patients pretreated with nicotinamide.

### Congenital Neurodevelopmental Disorders

It is well established that excess vitamin A administered to mothers in the prenatal period is associated with a multitude of neurodevelopmental disorders which may be an evolutionary mismatch disease from vitamin administration. An optimal dose of prenatal vitamin A should not exceed 10,000 units per day. There is no known restriction on beta carotene ingestion in the prenatal period; however, it is known that beta carotene crosses the placenta, and non-brown neonatal fat is white suggesting that beta carotene is not stored in fetal fat, but is metabolized probably to vitamin A. Although the carotenoids lutein and zeaxanthin are clearly stored in the fetus and newborn, these two carotenoids are not converted to vitamin A.[32] Beta carotene is symmetrically cleaved to retinol which is oxidized to the teratogenic 13-cis retinoic acid and less-teratogenic 13-trans retinoic acid, existing in equilibrium such that an increased concentration of 13-trans retinoic acid will increase the concentration of 13-cis retinoic acid. Therefore, the fetus of mothers who ingest indiscriminate amounts of beta carotene and ingest large quantities of vitamin A from prenatal vitamins and supplemented food may be exposed to high levels of 13-cis retinoic acid that is associated with neurodevelopment disorders.[33] Direct government funding for this translational research is needed.

Key concept: Beta carotene is probably metabolized by the human fetus to 13-cis retinoic acid which is teratogenic, and indiscriminate ingestion of beta carotene in pregnant women especially those prescribed prenatal vitamin A and who ingest supplemented foods should be further investigated.

### Diabetes

Diabetes is a common and devastating disease that affects millions associated with expensive morbidity and expensive therapies. From 1975-2005, the incidence of Type II diabetes increased seven-fold and is an evolutionary mismatched disease from diet and lack of physical activity. The mainstay of diabetes treatment is glucose control. Multiple medications are available for this purpose and continue to be developed with computer control administration. For decades, oral administration of inexpensive L-lysine has been known to lower blood glucose, and may be an adjunct therapy along with present medication regimes.[34] The oral bioavailability of L-lysine is well established, and concomitant administration of glucose with L-lysine has been shown to decrease the absorption of glucose.[35] The advanced glycation end products (AGE) formed when L-lysine non-enzymatically reacts with chain glucose and then irreversible rearranges to form the AGE will compete with other AGE products and may lower the overall burden. This process may be monitored by measuring levels of hemoglobin A1C. There is no profit incentive for a pharmaceutical company to conduct a clinical trial of inexpensive oral L-lysine for treatment of diabetes. Direct government funding for this translational research is needed.

Key concept: Inexpensive L-lysine can lower blood glucose through glycation and may lower AGE products and it is an adjunctive therapy for the treatment of diabetes.

### Spinal stenosis

Low back pain is a leading cause of U.S. disability. Spinal stenosis is a condition that favors the aging population and can affect cervical, thoracic, or lumbar vertebra for which analgesics, injection, and surgery are potential treatment options, each with significant side effects. In vitro, sodium citrate infused into the epidural space will dissolve the stenosis, which is composed primarily of CaHA, and citrate is unlikely to injure adjacent tissues such as the ligament flavum. A U.S. patent was assigned to this technology.[16] Direct government funding for this translational research is needed.

Key concept: Spinal stenosis can be treated with sodium citrate infused into the epidural space which will dissolve CaHA.

### Renal failure

The incidence of renal failure is increasing as the general population grows older, and renal failure from diabetes, systemic lupus glomerulonephritis, and interstitial disease from medication is increasing. Renal failure is treated by dialysis, either hemodialysis or peritoneal dialysis, or by renal transplantation for which there are inadequate supplies of donor kidneys. For years it has been known that sweat production produced in saunas and hot baths can aid kidneys in detoxification.[36, 37] Blood urea nitrogen (BUN) concentration in sweat can be 50× that of the plasma.[38] Sorbents can be added to hot baths to increase detoxification since the sorbents can lodge in the sweat glands optimizing toxin exchange.[39] In 1964, Yatzidis demonstrated the adsorption of renal failure toxins with charcoal.[40] Whether sweating and toxin absorption on sorbents in hot baths will be impeded by hydrostatic pressure on sweat glands will need to be empirically determined; however, weight loss is frequent after hot bath therapy and sauna. Weight loss can be a non-invasive monitor of the effectiveness of this therapy. Direct government funding for this translational research is needed.

Key concept: Inexpensive methods to induce sweating in hot baths with sorbents and sauna can aid in detoxification of renal failure patients.

### Mental Illness

Mental illness including depression, manic depression, and anxiety disorders may be evolutionary mismatch diseases of increasing human population density and human exposure to human produced electromagnetic radiation. Present therapy to treat the most intractable depression either from major depressive disorder (MDD) or manic depression (bipolar disorder) is electroconvulsive therapy (ECT) which is expensive and invasive.

The treatment of intractable depression with monoamine oxidase inhibitors (MAOI) and stimulants had been previously shown to be an effective drug therapy, but the number of practitioners who are comfortable and competent to prescribe monoamine oxidase inhibitors (MAOI) has declined, even though MAOI may be the most efficacious antidepressants for refractory MDD. There is in vitro evidence that monoamine oxidase deaminates gamma aminobutyric acid (GABA) in the CNS, and MAOI may increase CNS GABA levels in addition to increasing CNS concentrations of norepinephrine, epinephrine, serotonin, and dopamine.[41] Clinical trials are needed to assess combined therapy of MAOI and stimulants to treat MDD, but there is no pharmaceutical company incentive. Furthermore, a favorable outcome trial of combined therapy of MAOI and stimulants will encourage a renaissance of MAOI therapy that will lower costs and possibly complications associated with labor intensive transcranial stimulation and expensive ECT. A trial funded by the US government is needed since there is no incentive for a pharmaceutical company to conduct a trial.

Key concept: Treatment of refractory MDD may benefit from combination therapy of MAOI and stimulants, and clinical trials need to be conducted to determine efficacy and safety of this treatment.

### Model of the Blood Brain Barrier and Drug Permeability

Presently, predicting which drugs will pass through the human BBB is based on criteria such as the Lipinski rule of 4, in silico computer simulation, permeability of Caco-2 cells, partial artificial membrane permeability (PAMP) or immobilized artificial membrane (IAM) chromatography. The vitelline membrane is an unusual membrane that may predict molecular transit across the BBB.[42] The vitelline membrane has no anatomical similarities to the BBB, but has physiologic properties similar to the BBB when tested with a few low molecular weight compounds. More testing needs to be conducted to determine if the vitelline membrane is a good model of the human BBB, and this testing could be easily and inexpensively conducted. Development of this technology would simplify and decrease the cost of predicting a drug's passage across the BBB. At the present time, developing a drug that crosses the BBB is more costly and time consuming (12-16 years vs. 10-12 years) compared to developing a medication that treats other diseases that do not affect the CNS. There is no incentive for a pharmaceutical company to develop this technology.

Ester prodrugs may be ideal candidates for development of CNS drugs since the ester functional group increases lipophilicity compared to many alcohols, aldehydes and carboxylic acids, and ester prodrugs can be easily synthesized.[43] These prodrugs are conjugates of the active drug and molecules of ethanol, cholesterol, glucose, dexamethasone, and similar compounds known to have low toxicity in the CNS.[44-46] Esterases are abundant in the plasma and CNS, but the rate of plasma degradation will determine whether the prodrug will cross the BBB. Numerous examples such as procaine, 2-chloroprocaine, tetracaine, TEC, cocaine, heroin, TEC, etomidate, sobetirome, etc. have CNS effects even though some are metabolized in plasma.

Key concepts: 1. The vitelline membrane may be a simple, low-cost, predictable model of the human BBB. 2. Esters prodrugs can be easily synthesized and can cross the BBB where they can be hydrolyzed to an active CNS drug.

### Electric Energy Production

Energy production, particularly for electricity, is a continuous source of inflationary pressure on world economies, and energy usage is directly related to population growth. At the time of this writing, fossil fuels remain the primary source of energy to produce electricity through conversion of heat energy to kinetic energy to electricity through induction with turbines. Carnot efficiency limits conversion of heat to kinetic energy. Wind and solar sources of electricity provide non continuous electricity with storage problems.

Fuel cells are not considered mainstream sources of electricity, but zinc air fuel cells (ZAFC) can be inexpensively constructed of zinc, graphite, and salt water. These ZAFC can be recharged or the zinc metal recycled from the electrolyte. Photoreduction of Zn²⁺ and Zn(OH)⁺ within the electrolyte rapidly occurs when the ZAFC are coupled to solar cells. Photoreduction of the electrolyte is possible because this ZAFC operates in the pH range 6.5-8.5, and the energy to reduce the ions is significantly less than reducing zinc oxide (ZnO), the common waste product of traditional ZAFC. ZnO is not a predominant waste product in the pH range of this simple ZAFC. Catalytic solar carbothermal reduction of residual ZnO to Zn vapor to Zn and CO has been proposed but photoreduction of Zn²⁺ and Zn(OH)⁺ is more efficient.[47] Also attempts to decrease the internal resistance of this ZAFC introducing micropore carbon compounds of coal or charcoal to adsorb the waste products was not sustainable, and formation of zinc chloride species were wrongly predicted.[48, 49]

This ZAFC would allow electricity to be produced locally with limited environmental contamination and to improve efforts to combat global warming.[50] Also it may be unaffected from the consequences of electromagnetic pulses. Prior attempts to recharge ZAFC have not been economically feasible.[51] Utility companies have no incentive to develop this potentially disruptive technology. Direct government funding for this translational research is needed.

Key concept: Simple ZAFC, comprising zinc, graphite, and salt water, can be recharged by photovoltaic reduction or photovoltaic reduction of the electrolyte can reclaim zinc. This ZAFC is efficient, environmentally friendly, and inexpensive.

### Agriculture

Conceptually, agriculture technology has not changed in thousands of years. High energy costs for crops and livestock are subsidized in nearly all countries. Humans can easily survive and reproduce without animal food sources which include livestock, foul, and fish. High protein perennial food sources are a holy grail of agriculture, however, to date genetic engineering has not successfully developed a strain. High protein extracts can be processed from perennials such as perennial ryegrass with simple low velocity centrifugation with filtering, and subsequent microscopic examination of the filtrate for cellulose as quality control. Some extracts may require addition of citrate to disrupt the pectin bonds cross-linking cellulose, and some extracts may require non-activated charcoal purification.[52, 53] The extracts can be dried for preservation and incorporated into traditional foods. Growing and processing perennials for food will dramatically reduce costs and decrease the need for annual tillage. Symbiotic growing of legumes such as clover in the same field with perennial grasses will minimize use of nitrogen chemical fertilizers.[54] There is little incentive for manufacturers of agricultural equipment and chemical fertilizers to pursue this technology. Direct government funding for this translational research is needed.

Key concept: Costs for food production from repetitive tillage and chemical fertilizers can be greatly decreased by cultivation of high protein perennials grown symbiotically with legumes.

### Defense

National defense is a necessary expenditure which siphons funds from other programs that benefit society. The opportunity costs associated with military spending were eloquently orated by President Dwight Eisenhower:
“Every gun that is made, every warship that is launched, every rocket fired signifies in the final sense, a theft from those who hunger and are not fed, those who are cold and not clothed. This world in arms is not spending money alone. It is spending the sweat of its laborers, the genius of its scientists, the hopes of its children.”

Wars are the primary result of negotiations that do not resolve conflict. A method to improve the negotiation process has been described which may facilitate the selection of negotiators based on measurement of glutamate and GABA within voxels of their motor cortex imaged from non-invasive magnetic resonance spectroscopy (MRS) of presumptive negotiators during simulation challenges.[55] Prior art has demonstrated the validity of MRS of the motor cortex in decision-making. Neuroscience is developing predictive models of future behavior which can be incorporated into especially high stakes negotiations, and it would be wise to allocate resources to study these neuroscience links to human behavior.

Hyperscanning, the simultaneous measurement of brain activity of dyads or groups, has demonstrated that cooperative decision making is associated with interbrain synchrony. Simultaneous non-invasive monitoring of brain activity during intense conflict negotiations may facilitate creative resolutions during impasse conflict.[56, 57] Incorporating hyperscanning into simulated conflict negotiations should be quite easy, and, if there are positive results, could be initially incorporated into multi-track negotiations.

Within the CNS, ions transverse channels, and the velocity of the ions change as the pores open and close, producing electromagnetic waves which are summated in measurements such as electroencephalography (EEG)and magnetoencephalography (MEG). The interaction of external electromagnetic waves with the CNS has been controversial for decades, and there is a need for good clinical studies to determine if these effects are relevant to human behavior.[58, 59] In vitro studies show that chaotic systems which model some of CNS activity can be influenced by external electromagnetic waves.[60, 61] There is evidence that severity of psychiatric illness is related to external electromagnetic waves that change during the seasons.

The win-win resolution of conflict is the best resolution; however, it is often not attainable. Instead compromise (lose-loss) which requires all parties to lose is the common resolution in difficult negotiations; yet the compromise can be made more favorable when an outside party can add a substantial entity, often economic, to restructure the resolution to (lose-lose)-win, which serves to cushion the loses.[62] Such a strategy should be easy to implement when there is sincere incentive to resolve conflict.

Evil government leaders exist in the world and often command a diplomatic and military following. Evil is a subjective assessment. However, when world unanimity, not the majority, has decided that an evil leader disrupts the peace of the world, the evil leader should be incapacitated, which may be implemented by focused remote electromagnetic energy. Evil leaders should be judged fairly but not be spared. They should be subjected to punishment of incapacitation for the benefit of world harmony.[61, 63] It is outrageous that political leaders remain protected while their constituent followers suffer the physical and mental anguishes of war. Direct government funding for this translational research is needed.
“The world will not be destroyed by those who do evil, but by those who watch them without doing anything.”—Albert Einstein.

Key concepts: 1. Selection of international negotiators can be improved through MRS measurement of glutamate/GABA ratios within voxels of the motor cortex of presumptive negotiations who have been subjected to a simulation challenge. 2. Hyperscanning, monitoring simultaneous brain activity, during difficult negotiations may improve outcomes. 3. The CNS generates electromagnetic waves, and the interaction of external electromagnetic needs to be conclusively investigated for clinical effects. 4. Game theory of conflict resolution predicts that compromise (lose-lose) can be more favorably restructured to (lose-lose)-win resolution. 5. Government leaders who have been judged evil by unanimity of world leaders should be incapacitated by remote focused weapons.

### BRIEF DESCRIPTION OF THE DRAWINGS

FIG. 1 is a market equilibrium graph of full employment. Label 1 is real GDP and price level.

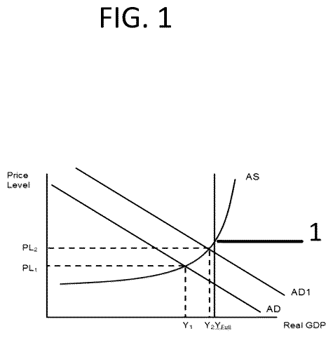

FIG. 2 is a market equilibrium graph of transformative translational scientific research. Label 1 is real GDP and price level.

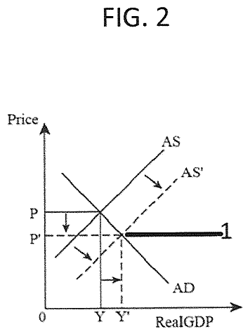

### BRIEF SUMMARY OF THE INVENTION

This invention is a method to improve the standard of living of societies of sovereign currency-issuing countries through funding of translational scientific research. Modern monetary theory (MMT) teaches full employment of the involuntary unemployed as a requisite for improved standard of living but does not articulate the details of the process, which is faced with numerous political hurdles and may be inflationary. Full employment will increase real GDP per capita but increase price levels, whereas direct government investment in translational scientific research will increase real GDP per capita and lower price levels. This invention describes numerous plausible translational scientific research proposals that sovereign currency-issuing governments can support to uplift the standard of living of their constituents. Direct government funding of this research will involve risks that corporations, nonprofits, and academia are not willing to assume, and successful development of these technologies may be disruptive to the status quo. Direct government funding for translational scientific research is needed.

### DETAILED DESCRIPTION OF THE INVENTION

Unfortunately, the “invisible hand” described by Adam Smith may not apply or lags scientific technological development that is disruptive to profit incentives of corporations, partnerships, or individuals. There is a need for direct government investment in translational scientific research, and sovereign currency-issuing governments have the capacity to assume the significant risk of direct investment into this research. Opportunity costs and risk to invest in translational scientific research are high and likely to deter corporations, nonprofits, and academia to pursue these studies. However, sovereign currency-issuing governments have available resources to pursue these investigations if there is political will. There is a risk that developing many of these translational concepts will not be successful.

Successful translational research outcomes from direct government investment will be transformative and improve the quality of life for constituents with increased real GDP per capita and lower costs but will not provide full employment as advocated in MMT. Research founded in the hard sciences of physics and chemistry has produced concepts and convincing experimental data that can be translated into practice to improve the standard of living of societies. This invention addresses investment in health care, energy, agriculture, and defense which will ultimately decrease the sovereign currency-issuing countries' deficit spending and debt.

Full employment of the involuntary unemployed as espoused in MMT may not eliminate structural and frictional causes of unemployment but may mitigate some unemployment associated with business cycles. The logistics of instituting public work programs for the involuntary unemployed are not trivial, and there are concerns that such programs will generate a work force of marginal productivity and MMT will increase prices. Full scale MMT has never been instituted in a sovereign currency-issuing economy, and inflation may climb to unacceptable levels. Therefore, proof of concept of MMT to help economies of sovereign currency-issuing countries has not been established. If sovereign currency issuing governments have the proclivity to spend, the risks of direct investment in translational scientific research will be less than development of full employment programs. In the U.S., investment in translational scientific research is a proven concept and action; however, sound translational scientific research needs to be proven through controlled trials in health care and large-scale empirical projects in energy, agriculture and defense.

### REFERENCES

ADDIN EN.REFLIST 1. Kelton, S., The deficit myth: modern monetary theory and the birth of the people's economy. First edition. ed. 2020, New York: PublicAffairs. vii, 325 pages.
2. Mitchell, W., Mosler, W., MODERN MONETARY THEORY Bill and Warren's Excellent Adventure. 2024, Madrid, Spain: Lola Books.
3. Streiner, D. L., Alternatives to placebo-controlled trials. Can J Neurol Sci, 2007. 34 Suppl 1: p. S37-41.
4. Segal, S. and J. Foley, The metabolism of D-ribose in man. J Clin Invest, 1958. 37(5): p. 719-35.
5. Goldberg, J. S., Stereocomplexes Formed From Select Oligomers of Polymer d-lactic Acid (PDLA) and I-lactate May Inhibit Growth of Cancer Cells and Help Diagnose Aggressive Cancers-Applications of the Warburg Effect. Perspect Medicin Chem, 2011. 5: p. 1-10.
6. Goldberg, J. S., Gooden, D. M., SYNTHESIS AND IN VITRO ACTIVITY OF D-LACTIC ACID OLIGOMERS US 2018/0273464 A1.
7. Goldberg, J. S., Weinberg, J. B., LOCAL APPLICATION OF D-LACTIC ACID DIMER IS SELECTIVELY CYTOTOXIC WHEN APPLIED TO CANCER CELLS US 9,382,376 B2.
8. Dikshit, A., et al., Potential Utility of Synthetic D-Lactate Polymers in Skin Cancer. JID Innov, 2021. 1(3): p. 100043.
9. Goldberg, J. S., INHIBITION OF GLYOLYSIS WITH 2-DEOXY-D-GLUCOSE AND D-LACTIC ACID DIMER US2020/0276216 A1.
10. Goldberg, J. S., AEROBIC GLYCOLYSIS AND HYPERMETABOLIC STATES US 2022/0206017 A1.
11. Goldberg, J. S., Atherosclerosis: Viewing the Problem from a Different Perspective Including Possible Treatment Options. Lipid Insights, 2011. 4: p. 17-26.
12. Villa-Bellosta, R., Vascular Calcification: Key Roles of Phosphate and Pyrophosphate. Int J Mol Sci, 2021. 22(24).
13. Moss, A.J., et al., Ex vivo (18)F-fluoride uptake and hydroxyapatite deposition in human coronary atherosclerosis. Sci Rep, 2020. 10(1): p. 20172.
14 Skwarek, E., W. Janusz, and D. Sternik, Adsorption of citrate ions on hydroxyapatite synthetized by various methods. J Radioanal Nucl Chem, 2014. 299(3): p. 2027-2036.
15. Kritchevsky, D., et al., Effect of injected choline citrate in experimental atherosclerosis. Am J Physiol, 1955. 183(3): p. 535-7.
16. Goldberg, J. S., CITRATE RESORPTION OF BONE AS A TREATMENT FOR SPINAL STENOSIS U.S. Pat. No. 9,616,040 B2.
17. Goldberg, J. S., MEDICINAL PROPERTIES OF TRIETHYL CITRATE U.S. Pat. No. 11,786,495 B2.
18. VanDeripe, D. R., METHOD OF USE OF GAS MIXTURES TO ACHIEVE WASHOUT OF NITROGEN FROM THE BODY AND MITOCHONDRIA U.S. Pat. No. 7,263,993 B2.
19. VanDeripe, D. R., Nitrogen Gas as an Opportunisitic Poison; and Washout therapies drifting in the fog. 2015, Lexington, KY.
20. Goldberg, J. S., METHOD TO DECREASE BRAIN INJURY FOLLOWING CEREBRAL ISCHEMIA US 2016/0228664 A1.
21. Goldberg, J. S., CITRATE DISSOLUTION OF BETA-2-MICROGLOBULIN AND AMYLOID BETA PEPTIDE(1-40) AGGREGATES US 2018/0333379 A1.
22. Bertoch, T., et al., Suzetrigine, a Non-Opioid NaV1.8 Inhibitor for Treatment of Moderate-to-Severe Acute Pain: Two Phase 3 Randomized Clinical Trials. Anesthesiology, 2025.
23. Karri, J., R. S. D′Souza, and S. P. Cohen, Between promise and peril: role of suzetrigine as a non-opioid analgesic. BMJ Med, 2025. 4(1): p. e001431.
24. Goldberg, J. S., ANALGESIA FROM ORAL PROCAINE A FORGOTTEN VOLTAGE GATED SODIUM CHANNEL BLOCKER US 2024/0130998 A1.
25. Goldberg, J. S., PDLA a potential new potent topical analgesic: a case report. Local Reg Anesth, 2014. 7: p. 59-61.
26. Goldberg, J. S., USE OF POLYMER D-LACTIC ACID (PDLA) TO TREAT PAIN US 2015/0182481 A1.
27. Goldberg, J. S., Chronic opioid therapy and opioid tolerance: a new hypothesis. Pain Res Treat, 2013. 2013: p. 407504.
28. Goldberg, J. S., TRANSCRANIAL MAGNETIC LESIONING OF THE NERVOUS SYSTEM FOR RELIEF OF INTRACTABLE PAIN US 2017/0189709 A1.
29. Goldberg, J. S., USE OF POLYMER D-LACTIC ACID (PDLA) TO TREAT MALARIA US 2015/0182553 A1.
30. Goldberg, J. S., TREATMENT OF AMYOTROPHIC LATERAL SCLEROSIS WITH LACTATE US 2016/0271085 A1.
31 Goldberg, J. S., SODIUM L-LACTATE INFUSION FOR EARLY DIAGNOSIS OF PARKINSON'S DISEASE US 2024/0016441 A1.
32. Giordano, E. and L. Quadro, Lutein, zeaxanthin and mammalian development: Metabolism, functions and implications for health. Arch Biochem Biophys, 2018. 647: p. 33-40.
33. Goldberg, J. S., Monitoring maternal Beta carotene and retinol consumption may decrease the incidence of neurodevelopmental disorders in offspring. Clin Med Insights Reprod Health, 2011. 6: p. 1-8.
34. Goldberg, J. S., GLYCATION OF L-LYSINE TO LOWER BLOOD GLUCOSE AND TREAT COMPLICATIONS OF DIABETES US 2015/0182483 A1.
35. Natarajan Sulochana, K., et al., Effect of oral supplementation of free amino acids in type 2 diabetic patients--a pilot clinical trial. Med Sci Monit, 2002. 8(3): p. CR131-7.
36. al-Tamer, Y. Y., E. A. Hadi, and B. al, II, Sweat urea, uric acid and creatinine concentrations in uraemic patients. Urol Res, 1997. 25(5): p. 337-40.
37. Ye, T., W. Tu, and G. Xu, Hot bath for the treatment of chronic renal failure. Ren Fail, 2014. 36(1): p. 126-30.
38. Huang, C. T., et al., Uric acid and urea in human sweat. Chin J Physiol, 2002. 45(3): p. 109-15.
39. Goldberg, J. S., METHOD OF INEXPENSIVE TRANSEPITHELIAL DIALYSIS WITH HOT WATER BATH AND SORBENTS US 2015/0190426 A1.
40. Yatzidis, H., [Research on Extrarenal Purification with the Aid of Activated Charcoal]. Nephron, 1964. 1: p. 310-2.
41. Goldberg, J. S., C. E. Bell, Jr., and D. A. Pollard, Revisiting the monoamine hypothesis of depression: a new perspective. Perspect Medicin Chem, 2014. 6: p. 1-8.
42. Goldberg, J. S., VITELLINE MEMBRANE AS A MODEL OF THE BLOOD BRAIN BARRIER US 2017/0299579 A1.
43. Goldberg, J. S., NOVEL SYNTHESIS OF POTENTIAL ESTER PRODRUGS US 2017/0165371 A1.
44. Goldberg, J. S., OPIOID PEPTIDE ESTERS AND METHODS OF USE US 2013/0072438 A1.
45. Goldberg, J. S., Selected Gamma Aminobutyric Acid (GABA) Esters may Provide Analgesia for Some Central Pain Conditions. Perspect Medicin Chem, 2010. 4: p. 23-31.
46. Goldberg, J. S., Low Molecular Weight Opioid Peptide Esters Could be Developed as a New Class of Analgesics. Perspect Medicin Chem, 2011. 5: p. 19-26.
47. Goldberg, J. S., Bhatt, A. M., ZINC AIR FUEL CELL FOR RENEWABLE AND SUSTAINABLE ENERGY US 2022/0302485 A1.
48. Goldberg, J. S., RENEWABLE, RECHARGEABLE, INEXPENSIVE ZINC/NATURAL CARBON/GRAPHITE AIR FUEL CELL US 2015/0037709 A1.
49. Goldberg, J. S., NOVEL ZINC AIR FUEL CELL WITH LONGEVITY US 2019/0296409 A1.
50. Goldberg, J. S., PHOTOVOLTAIC REDUCTION OF WASTE CATIONS FROM ZINC AIR FUEL CELLS US 2023/0216111 A1.
51. Nazir, G., et al., A Review of Rechargeable Zinc-Air Batteries: Recent Progress and Future Perspectives. Nanomicro Lett, 2024. 16(1): p. 138.
52. Goldberg, J. S., DECALCIFICATION OF PASTURE GRASS FOR FOOD AND FUEL US 2016/0270425 A1.
53. Goldberg, J. S., PROCESSING OF PERENNIAL RYE GRASS (LOLIUM PERENNE) FOR HUMAN CONSUMPTION US 2019/0281864 A1.
54. Goldberg, J. S., SUSTAINABLE FOOD SOURCE FROM PERENNIAL GRASS US 2022/0151256 A1.
55. Goldberg, J. S., NEUROSCIENCE AND CONFLICT RESOLUTION US 2024/0389924 A1.
56. Goldberg, J. S., Jackson, C. L., METHOD TO IMPROVE OUTCOMES DURING NEGOTIATIONS US 2020/0108264 A1.
57. Goldberg, J. S., OXYGEN REDUCTION REACTIONS AND INTERBRAIN SYNCHRONY US 2023/0041085 A1.
58. Goldberg, J. S., COHERENT ELECTROMAGNETIC WAVES AID RECONCILIATION US 2016/0302667 A1.
59. Goldberg, J. S., METHOD TO OPTIMIZE ELECTRODE PLACEMENT FOR CRANIAL ELECTRICAL STIMULATION US 2016/0129238 A1.
60. Goldberg, J. S., THERMODYNAMIC MODEL OF A NERVOUS SYSTEM US 2015/0379898 A1.
61. Goldberg, J. S., METHOD TO MAINTAIN PEACE THROUGH ELECTROMAGNETIC ENERGY TARGETED TO THE BRAIN US 2016/0375220 A1.
62. Goldberg, J. S., (LOSE-LOSE)-WIN RESOLUTION OF CONFLICT US 2020/0349667 A1.
63. Goldberg, J. S., REGULATION OF THALAMIC ACTIVITY FOR CONTROL OF AGGRESSION US 2019/0030335 A1.

Having described my invention, I claim:

1. A method to increase a real GDP per capita and to lower a price level of a sovereign currency-issuing country through an investment in a translational scientific research.

2. The method of claim 1. wherein a translational scientific research comprises a photocell and a zinc air fuel cell.

3. The method of claim 2. wherein the zinc air fuel cell comprises zinc, graphite, and salt water.

4. The method of claim 1. wherein a translational scientific research is an antiglycolytic therapy comprises 2-Deox-D-Glucose (2DG) and D-Lactic Acid Dimer (DLAD).

5. The method of claim 1. wherein a translational scientific research is denitrogenation of a human ischemic tissue.

6. The method of claim 1. wherein a translational scientific research is a therapy comprised of a chelation of a calcium ion with a citrate ion.

7. The method of claim 1. wherein a translational scientific research is L-lactate administration to a human.

8. The method of claim 1. wherein a translational scientific research is L-lysine administration to a diabetic human.

9. The method of claim 1. wherein a translational scientific research is a sweat therapy for a detoxification of a uremic human.

10. The method of claim 1. wherein a translational scientific research is D-Lactic Acid Dimer (DLAD) sequestration of L-lactate.

11. An economic process of a sovereign currency-issuing country investment in a translational scientific research.

12. The economic process of claim 11. wherein a translational scientific research comprises health care spending of the sovereign currency-issuing country.

13. The economic process of claim 11. wherein a translational scientific research comprises defense spending of the sovereign currency-issuing country.

14. The economic process of claim 11. wherein a translational scientific research comprises energy production of the sovereign currency-issuing country.

15. The economic process of claim 11. wherein a translational scientific research comprises agriculture production of the sovereign currency-issuing country.

16. A model of a sovereign currency-issuing country investment in a translational scientific research.
